(19) United States
(12) Patent Application Publication
(10) Pub. No.: US 2002/0132106 A1
(43) Pub. Date: Sep. 19, 2002

(54) Fiber reinforced FOAM composites derived from high internal phase emulsions

(76) Inventors: John Collins Dyer, Cincinnati, OH (US); Mario Elmen Tremblay, West Chester, OH (US); Robert Joseph McChain, Cincinnati, OH (US); Edward Creston Smith, Cincinnati, OH (US); Thomas Allen DesMarais, Cincinnati, OH (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(21) Appl. No.: 09/992,640

(22) Filed: Nov. 6, 2001

Related U.S. Application Data
(60) Provisional application No. 60/246,376, filed on Nov. 7, 2000.

(51) Int. Cl. B65B 1/00; B65C 1/00; B31B 1/60; B32B 31/00; B32B 5/02; A62B 7/08; B32B 27/04; B32B 27/12; B32B 3/26; B32B 5/24; D21H 11/00; D21H 13/00; B32B 5/22

(52) U.S. Cl. 428/317.9; 428/311.11; 428/311.51; 156/60; 422/120

(57) ABSTRACT

The invention relates to foam composites having improved properties. These polymeric foams are prepared by polymerization of certain water-in-oil emulsions having a relatively high ratio of water phase to oil phase, commonly known in the art as high internal phase emulsions, or “HIPEs.” The HIPE-derived foam materials used in the present invention comprise a generally hydrophobic, flexible, semi-flexible, or rigid nonionic polymeric foam structure of interconnected open-cells. These foam structures have a density of less than about 100 mg/cc, a glass transition temperature (Tg) of between about −40° and 90° C., and at least about 1% by weight compatible fibers incorporated into the foam. The foam composites have improved tensile properties compared to foams having no incorporated fibers or foams having noncompatible fibers incorporated therein.

### CROSS REFERENCE TO A RELATED PATENT

This application claims priority to co-pending and commonly-owned, U.S. Provisional Application Serial No. 60/246,376, Case 8319P, titled, “Fiber Reinforced Foam Composites Derived from High Internal Phase Emulsions”; filed Nov. 7, 2000, in the name of John C. Dyer et al.

### FIELD OF THE INVENTION

This application relates to foam composites made from high internal phase emulsions containing compatible fibers. This application further relates to uses thereof.

### BACKGROUND OF THE INVENTION

The development of open-celled foams has been the subject of substantial commercial interest. The literature is replete with applications for open-celled foams in areas such as insulation, packaging, in light-weight structural members, buoyancy, filtration, carriers for inks and dyes, use as an absorbent material, and the like. A specific type of open-celled foams are made from high internal phase emulsions, hereinafter HIPE foams. Such foams can be tailored with respect cell size, glass transition temperature, density, surface treatments, durability, and the like. This has enabled these HIPE foams to be optimized for a variety of uses. For example, U.S. Pat. No. 4,606,958 (Haq et al.) issued Aug. 19, 1986 describes an absorbent substrate such as a cloth or a towel prepared from a sulfonated styrenic HIPE foam for mopping up household spills. U.S. Pat. No. 4,536,521 (Haq) issued Aug. 20, 1985 describes similar HIPE foams which can act as ion exchange resins. U.S. Pat. No. 4,522,953 (Barby et al.) issued Jun. 11, 1985 describes use of HIPE foams as reservoirs for carrying liquids. U.S. Pat. No. 5,021,462 (Elmes et al.) issued Jun. 4, 1991 describes HIPE foams useful in a filter body, as a catalyst support, and as a containment system for toxic liquids. U.S. Pat. No. 4,659,564 (Cox et al.) issued Apr. 21, 1987 describes use of HIPE foams for absorbing axillary perspiration. U.S. Pat. No. 4,797,310 (Barby et al.) issued Jan. 10, 1989 describes HIPE foam substrates useful for delivering or absorbing liquids such as cleaning compositions. Other uses cited include hand and face cleaning, skin treatment other than cleaning, baby hygiene, cleaning, polishing, disinfecting, or deodorizing industrial and domestic surfaces, air freshening, perfume delivery, and hospital hygiene. U.S. Pat. No. 4,966,919 (Williams et al.) issued Oct. 30, 1990 describes use of certain HIPE foams for containing the deuterium/tritium fuel needed for a laser induced fusion reactor. PCT application serial No. 97/37745 (Chang et al.) published Oct. 16, 1997 describes a filter material made from a HIPE foam wherein the foam is attached prior to polymerization to a substrate felt for support. U.S. Pat. No. 3,763,056 (Will) issued Oct. 2, 1973 discloses HIPE foams with numerous uses, including construction, furniture, toys, molded parts, casings, packaging material, filters, and in surgical and orthopedic applications.

U.S. Pat. No. 3,256,219 (Will) issued Jun. 14, 1966 discloses uses wherein the HIPE is applied to a substrate prior to polymerization for use in insulation, flooring, wall and ceiling coverings or facings, as breathable artificial leather, separators for storage batteries, porous filters for gases and liquids, packing material, toys, for interior decoration, orthopedic devices, and as a cork substitute. While Will discloses that it may be advantageous to admix fibers within the HIPE foam, it fails to recognize the necessity for the fiber to be sufficiently compatible with the HIPE so as to become tightly entrained therein. Nor does this art teach suitable fiber lengths or the method of fiber inclusion into the resulting HIPE foam. HIPE foams are also useful for insulation. U.S. Pat. Nos. 5,633,291 (Dyer et al.) issued May 27, 1997, 5,770,634 (Dyer et al.) issued Jun. 23, 1998, 5,728,743 (Dyer et al.) issued Mar. 17, 1998, and U.S. Pat. No. 5,753,359 (Dyer et al.) issued May 19, 1998 describe such foam materials used for insulation and are included herein by reference. These patents describe in part the utility of such fine-celled foams in insulation as a means of reducing the radiative transmission of thermal energy. These patents further disclose the utility of including particles therein that reduce transmission of light in the infrared region. Exemplary particles include carbon black and graphite. However, these particles are not tightly entrained in the HIPE foam matrix and do not confer any benefit with respect to the toughness of said foams.

U.S. Pat. No. 5,817,704 (Shiveley et al.) issued Oct. 6, 1998 discloses uses for heterogeneous HIPE foams including environmental waste oil sorbents, bandages and dressings, paint applicators, dust mop heads, wet mop heads, in fluid dispensers, in packaging, in shoes, in odor/moisture sorbents, in cushions, and in gloves. HIPE foams have also been cited for utility in disposable absorbent products such as diapers and catamenials. Exemplary patents are U.S. Pat. No. 5,650,222 (DesMarais et al.) issued Jul. 22, 1997 and U.S. Pat. No. 5,849,805 (Dyer) issued Dec. 15, 1998. The latter cites utility in bandages and surgical drapes, inter alia. PCT application WO 01/32761, published May 10, 2001 in the name of Dyer et al., describes uses for HIPE foams including in toys, wipes, applicators, artistic media, targets, stamps, wet play devices, learning devices, and the like. The above citations are incorporated herein by reference.

HIPE derived foams have been disclosed for use in air filtration. For example, the aforementioned PCT application (97/37745, Chang et al.) discloses a filter material prepared from a porous substrate impregnated with a HIPE which is then polymerized. Two publications, Walsh et al. J. Aerosol Sci. 1996, 27(Suppl. 1), 5629-5630, and Bhumgara Filtration & Separation March 1995, 245, disclose the use of HIPE derived foams for air filtration. There above citations are incorporated herein by reference.

HIPE foams have also been used as enzyme supports and to facilitate microbial growth. See for example Ruckenstein, E. Adv. Polym. Sci. 1997, 127, 1-58.

It would further be desirable to increase the toughness or durability of HIPE foams for use in applications where they must endure stress applied to the surface. HIPE foams with comparatively higher abrasion resistance have been developed that use a relatively high level of a toughening monomer (such as styrene) with respect to the level of crosslinking monomer within the formulation. This is described in more detail in PCT application WO 99/46319 published in the name of Roetker et al. on Sep. 16, 1999. However, in some cases, it is desirable to confer even greater toughness or abrasion resistance without using such relatively high levels of toughening monomer, or to develop a given level of toughness or abrasion resistance with HIPE foams of lower density.

In further extending the utility of the class of foams, various additional potential benefits may be envisioned. Exemplary uses include: HIPE foams having the ability to trap odiferous gases and other impurities from gas streams; HIPE foams that containing color or tint to enhance the aesthetics of the material for certain uses; HIPE foams having enhance the thermal insulation efficiency (e.g., by inclusion of materials opaque in the infrared region).

### SUMMARY OF THE INVENTION

The present invention relates to the modification of HIPE-derived polymeric foam materials by inclusion of compatible fibers. The polymeric foams are prepared by polymerization of High Internal Phase Emulsions, commonly known in the art as “HIPEs.” As used herein, polymeric foam materials which result from the polymerization of such emulsions are referred to hereafter as “HIPE foams.” The HIPE foams used in the present invention comprise a nonionic polymeric low density, open celled, high surface area foam structure having dispersed therein compatible fibers, hereinafter denoted “foam composites”. These foam structures have a density of less than about 100 mg/cc, a glass transition temperature of between about −40° and 90° C., and at least about 1% by weight compatible fibers incorporated into the foam.

Such HIPE foams are prepared via polymerization of a HIPE comprising a discontinuous water phase and a continuous oil phase wherein the ratio of water to oil is at least about 4:1, preferably at least about 10:1, more preferably at least about 15:1, and still more preferably at least about 20:1. The water phase generally contains an electrolyte and a water soluble free radical initiator. The oil phase generally consists of substantially water-insoluble monomers that are polymerizable by free radicals, an emulsifier, and other optional ingredients defined below. The monomers are selected so as to confer the properties desired in the resulting HIPE foam (e.g. a glass transition (Tg) between about −40° C. and 90° C., mechanical integrity sufficient for the end use, and economy). Compatible fibers are added to the HIPE prior to curing (polymerization and crosslinking of the monomer component of the oil phase of the HIPE). After curing the HIPE, a HIPE foam is obtained containing compatible fibers dispersed therein. These HIPE foams containing fibers are hereinafter termed “foam composites”.

Suitable fibers for modification of the HIPE foams to form these foam composites will be compatible in the general sense that their surface chemistry will not significantly disrupt the HIPE structure into which they are dispersed. In general, hydrophilic fibers, hereinafter defined, are disruptive to the HIPE and form poor interconnectivity between the resulting polymeric foam and the fiber surface. In contrast, compatible fibers do not significantly disrupt the HIPE structure adjacent the fiber. Compatible fibers are therefor intimately associated with the polymer of the resulting HIPE foam and form a strong bond between the two materials.

The resulting “composite foams” show, under photomicrographic examination, fibers intercalated intimately within the HIPE foam microstructure. Without being bound by theory, it is believed that the reinforcing feature seen with fiber incorporation is related to the affinity with which the HIPE polymer associates with the fiber surface. A particular benefit of this affinity and resulting association is that the fibers reinforce the HIPE foams increasing the toughness of the composites so formed. Other benefits of certain fibers include enhanced particulate filtration, odor adsorption, appearance modification, and absorption of infrared radiation (of value specifically in thermal insulation).

### BRIEF DESCRIPTION OF THE DRAWINGS

FIG. 1 is a photomicrograph (500×magnification) of a cut section of a representative foam composite useful in the present invention made from the HIPE described as Example 1b in Table 1 containing 3% ACF added to the HIPE prior to curing.

FIG. 2 is a photomicrograph (100×magnification) is a comparative example of a cut section of a representative foam composite useful in the present invention made from the HIPE described as Comparative Example 2b in Table 2 containing 2% fibrillated cellulosic fiber added to the HIPE prior to curing.

FIG. 3 is a schematic longitudinal cross section of an exemplary filtration device according to the present invention.

### DETAILED DESCRIPTION OF THE INVENTION

The fiber composites of the present invention possess any of several desirable properties. A non-limiting list of these desirable properties includes the ability to filter fine particulates from fluid streams, absorb odors from gaseous streams, improved toughness, improved visual appearance, and improved thermal insulation properties. The fibers may be entrained at the level desired by mixing with the HIPE prior to curing by any suitable means so as to achieve the desired level of dispersion within the resulting HIPE foam. The type of fibers used may comprise any type compatible with the HIPE. As used herein, a “compatible fiber” is one which:

1) can be dispersed throughout a HIPE with minimal clumping; and

2) will not destabilize the HIPE during formation and curing or induce coalescence in the region surrounding the fibers.

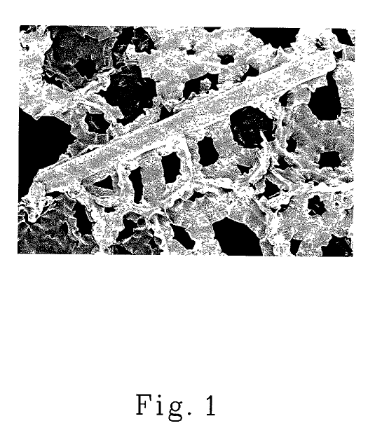

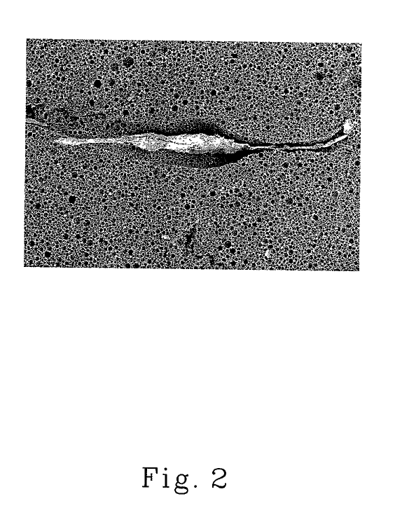

Without being bound by theory, it is believed that compatible fibers have surface properties such that they are sufficiently wettable by the dispersed phase of the HIPE (the aqueous phase) so they can be dispersed evenly while, at the same time, being highly wettable by the continuous phase of the HIPE (the oil phase) so as to form an intimate association. It is believed that it is undesirable for both the phases to spread significantly on the fiber surface because such spontaneous wetting can interfere with the phase boundary between the phases leading to coalescence. Fibers found to be compatible with the HIPE generally are those which have a relatively hydrophobic surface. Such compatible fibers result in the fiber element being disposed within the microstructure of the HIPE foam after the HIPE is cured. As shown in FIG. 1, this is clearly the case for the foam composites of the present invention. As shown in FIG. 2, incompatible fibers do not show this intimate association between fiber and foam matrix.

The use of incompatible fibers will induce destabilization within the HIPE that can be seen, for example, in photomicrographs of the resulting HIPE foams. The immediate vicinity of such incompatible fibers will often be substantially void of the HIPE foam and no association between the HIPE foam polymer and the fiber will be visible. Without being bound by theory, this is taken as evidence that HIPE in the immediate vicinity of an incompatible fiber will tend to break (coalesce and lose the microstructure of the HIPE) leaving this void region. As a result, the fiber will generally not be entrained tightly within the resulting HIPE foam. Incompatible fibers are generally those with a relatively hydrophilic surface

The use of particulate adjuvants in HIPE foams has also been contemplated. However, such particulate in general are found to be more loosely associated with the HIPE polymer than compatible fibers. Manipulation of foam composites formed using particulates generally results in release of such particulates into the environment as free particles. For particulates which are completely wetted by the oil phase, they may in some cases be tightly entrained within the resulting HIPE foam. However, the benefit of such addition can be very slight in terms of reinforcement and/or utilization of the surface properties of such additives (such as activated carbon powder for example). The aspect ratio of the fibrous adjuvants of the present invention result in superior containment and exposure of the fiber surface.

I. Characteristics of Foams Composites

A. Compatible Fiber Types

Compatible fibers are wettable enough to be compatible with the HIPE without inducing significant coalescence. Compatible fibers will generally have a critical surface tension (CST) of between about 15 and about 50 dynes/cm, more preferably between about 20 and about 40 dynes/cm. A higher CST value will generally be too hydrophilic and will induce coalescence in the HIPE in the region around the fiber. A lower CST will generally be more difficult to disperse within the HIPE. Fibers with a sufficiently low CST (e.g., less than about 50 dynes/cm) will generally lack polar groups on the surface including such moieties as amines, amides, hydroxyls, carbonyl groups, charged groups of any kind, sulfoxides, amine oxides, and the like.

A nonlimiting list of fibers which have the surface properties compatible with the HIPE includes hydrophobic fibers comprising basaltic minerals, glass, carbon (e.g., graphitic fibers, “charred” or carbonized fibers including carbonized polyacrylonitrile fibers, etc.), polyethylene, polypropylene, polyacrylonitrile, aramid, polyesters, polyalkyl acrylates, and the like. A particularly preferred compatible fiber according to the present invention are activated carbon fibers, hereinafter termed “Activated Carbon Fiber” or “ACF”.

The manufacture of activated carbon fibers is described thoroughly in the literature and such fibers are available commercially from several sources. As discussed above, in general, carbonized fibers are made by carbonizing polyacrylonitrile (PAN), phenol resin, pitch, cellulose fiber or other fibrous carbon surfaces in an inert atmosphere. The raw materials from which the starting fibers are formed are varied, and include pitch prepared from residual oil from crude oil distillation, residual oil from naphtha cracking, ethylene bottom oil, liquefied coal oil or coal tar by treatment such as filtration purification, distillation, hydrogenation or catalytic cracking. The starting fibers may be formed by various methods, including melt spinning and melt blowing. Carbonization and activation provide fibers having higher surface areas. For example, activated carbon fibers produced from petroleum pitch are commercially available from Anshan East Asia Carbon Fibers Co., Inc. (Anshan, China) as Carboflex® pitch-based Activated Carbon Fiber materials, and Osaka Gas Chemicals Co., Ltd. (Osaka, Japan) as Renoves A® series-AD'ALL activated carbon fibers. The starting materials are a heavy petroleum fraction from catalytic cracking and a coal tar pitch, respectively, both of which must be purified to remove fines, ash and other impurities. Pitch is produced by distillation, thermal cracking, solvent extraction or combined methods. Anshan's Carboflex® pitch-based activated carbon fiber materials are 20 μm in diameter with a specific surface area of about 1,000 m²/g. They come in various lengths such as:

P-200 milled activated carbon fibers: 200 μm length

400 milled activated carbon fibers: 400 μm length

600 T milled activated carbon fibers: 600 μm length

3200 milled activated carbon fibers: 3.2 mm length

6 chopped activated carbon fibers: 6 mm length Osaka Gas Chemicals' Renoves A® series-AD'ALL activated carbon fibers are 18 μm in diameter with various specific surface areas ranging from 1,000 to 2,500 m²/g. They come in various lengths, including (the specific surface areas are noted parenthetically):

A-15—Milled AD'ALL activated carbon fibers: 700 μm length (1500 m²/g)

A-20—Milled AD'ALL activated carbon fibers: 700 μm length (2000 m²/g)

A-15—Chopped AD'ALL activated carbon fibers: 6 mm length (1500 m²/g)

A-20—Chopped AD'ALL activated carbon fibers: 6 mm length (2000 m²/g)

A-10—Random lengths AD'ALL activated carbon fiber: random lengths (1000 m²/g)

A-10—Random lengths AD'ALL activated carbon: random length (1500 m²/g)

A-20—Random lengths AD'ALL activated carbon: random length (2000 m²/g)

A-25—Random lengths AD'ALL activated carbon: random length (2500 m²/g)

Additional details regarding ACFs are described in U.S. Patent application Serial No. 09/347223, filed in the name of Jagtoyen, et al. on Jul. 2, 1999.

For situations where the sorption properties of ACFs are not necessary (e.g., mechanical property enhancement), carbon fibers have been found to be compatible. Carbon fibers are produced commercially from rayon, phenolics, polyacrylonitrile (PAN), or pitch. The pitch type is further divided into fiber produced from isotropic pitch precursors, and those derived from pitch that has been pre-treated to introduce a high concentration of carbonaceous mesophase. High performance fibers, i.e. those with high strength or stiffness, are generally produced from PAN or mesophase pitches. Lower performance, general purpose fibers are produced from isotropic pitch precursors. The general purpose fibers are produced as short, blown fibers (rather than continuous filaments) from precursors such as ethylene cracker tar, coal-tar pitch, and petroleum pitch prepared from decant oils produced by fluidized catalytic cracking. Applications of isotropic fibers include: friction materials; reinforcements for engineering plastics; electrically conductive fillers for polymers; filter media; paper and panels; hybrid yards; and as a reinforcement for concrete. Suitable carbon fibers are available from Grafil, Inc. of Sacramento, Calif.

Fibers which generally have CSTs that are too high includes more hydrophilic fibers comprising cellulose, sodium polyacrylate, polyvinyl alcohols, and polyamides. While these incompatible fiber types may be added to the HIPE during the process, only a relatively low level (e.g., 1-5%) of such fibers may be added without visibly destabilizing the HIPE.

Some apparently hydrophilic fibers remain useful if the surface is modified with an agent that renders the fiber compatible with the HIPE. Often, process aids added during spinning may evoke this response. Thus, even hydrophilic rayon fibers may be used if a sufficiently hydrophobic surface has been created by virtue of an added processing agent. Similarly, such hydrophobic agents may be added intentionally to make an otherwise incompatible fiber compatible and hence within the scope of the present invention. Exemplary of such treatments are dialkyldimethyl ammonium salts which are also useful as coemulsifiers for forming HIPEs and which can be substantive to certain types of fibers, especially those which are cellulosic.

The length of the fiber is also important. Fibers longer than about 5 mm tend to clump together and remain incompletely dispersed. For this reason, shorter fibers are preferred. Compatible fibers generally are those which are short enough to be dispersed (typically having a length of less than about 5 mm, preferably less than about 3.5 mm, more preferably less than about 1.5 mm). Minimum fiber length has been found to depend on mean cell diameter. Specifically, minimum fiber length should be such that the fiber is able to traverse through at least two cells. For example, for a HIPE foam having a mean cell diameter of 100 μm, fibers having a length greater than about 200 mμ would be satisfactory. Therefore, for a typical HIPE foam, suitable fibers have a length extending from about 200 mμ to about 5 mm, preferably from about 200 mμ to about 3.5 mm.

Obviously, it may also be useful to add a “tow fiber”, e.g., one that is not cut and is of indeterminate length, to the HIPE to form a different type of composite foam. Such composite foams would have increased tensile strength owing to the reinforcing nature of the continuous tow fiber dispersed therein. Such long fibers may be primarily oriented in one or more directions, be randomly intertwined within the HIPE foam structure, be looped, or form a general mesh or grid-like configuration within the HIPE foam structure.

FIG. 1 of the drawings shows an example foam having dispersed therein ACFs having a length of about 0.2 mm exemplary of compatible fibers. FIG. 2 shows an example foam having dispersed therein a highly fibrillated cellulosic fiber which is characteristic of an incompatible type. Note that the HIPE in the region of the fiber has destabilized and pulled away from the fiber, thereby not forming any association between the HIPE foam and the surface of the fiber.

Fiber loading levels within the foam composite are also important. Generally, the fiber loading levels are determined gravimetrically from the amount of fiber added relative to the amount of monomer used. That is, a composite that is nominally 2% fiber would comprise 100 parts of the monomer component and 2 parts fiber. This is an approximation and can over-estimate the amount of fiber in the middle of the foam composite because of fiber movement during curing due to buoyant forces and the like. The outer boundary of the cured foam composite may be enriched in fiber in certain cases. In some applications, this outer boundary is layer is removed. Fiber loading may also be intentionally heavier in some areas and lighter in others as needed for the particular application.

When more precise determinations of fiber level are needed, specific analytical tests for the fiber in question may be applied. As will be recognized, such testing will depend on the specific nature of the fibrous material. The values used herein are estimates based on the calculated fiber:oil ratio. It should be noted that the W:O ratios cited herein specifically do not include the fiber component of the oil phase. The density of the resulting foam composite does include the contribution of the fiber to the weight of the resulting foam composite.

B. Foam Composite Microstructure

The foam composites used in accordance with the present invention are highly open-celled. This means the individual cells of the foam are in complete, unobstructed communication with adjoining cells. The cells in such substantially open-celled foam structures have intercellular openings or “windows” connecting one cell to the other within the foam structure.

These substantially open-celled foam structures will generally have a reticulated character with the individual cells being defined by a plurality of mutually connected, three dimensionally branched webs. The strands of polymeric material making up these branched webs can be referred to as “struts.” Open-celled foams having a typical strut-type structure are shown by way of example in the photomicrographs of FIGS. 1 and 2. As used herein, a foam material is “open-celled” if at least 80% of the cells in the foam structure that are at least 1 μm in size are in open communication with at least one adjacent cell.

The sizes of the cells of the foam may be varied according to need. In general, the greater the shear applied during emulsification, the smaller the water droplets in the emulsion and the finer the cellular microstructure of the ensuing foam. The term “cell size” is refers to the diameter of the cells formed around the disperse phase droplets of the emulsion during polymerization. Cell size can be assessed by several techniques. Foam cells, and especially cells that are formed by polymerizing a monomer-containing oil phase that surrounds relatively monomer-free water-phase droplets, will frequently be substantially spherical in shape. The size or “diameter” of such spherical cells is a commonly used parameter for characterizing foams in general. Since cells in a given sample of polymeric foam will not necessarily be of approximately the same size, an average cell size, i.e., average cell diameter, will often be specified.

A number of techniques are available for determining the average cell size of foams. The most useful technique, however, for determining cell size in foams involves a simple measurement based on the scanning electron photomicrograph of a foam sample. FIG. 1, for example, shows a typical foam composite structure according to the present invention. Superimposed on the photomicrograph is a scale representing a dimension of 50 μm. Such a scale can be used to determine average cell size via an image analysis procedure or by manual estimation and averaging.

The cell size measurements given herein are based on the number average cell size of the foam in its expanded state, e.g., as shown in FIG. 1. The foam composites of the present invention will preferably have a number average cell size between about 10 μm and 130 μm, and most preferably between about 15 μm to 85 μm. For filtration applications, more specifically for gas filtration, a balance between efficiency of removal of contaminant, thickness of the filter element, and back pressure caused by the filter element will be derived as needed by the specifics of the application.

C. Foam Composite Glass Transition Temperature (Tg)

A key parameter of these foams is their glass transition temperature (Tg). The Tg represents the midpoint of the transition between the glassy and rubbery states of the polymer and can be measured as described in U.S. Pat. No. 5,817,704 (Shiveley et al.) issued Oct. 6, 1998. Foams that have a Tg higher than the temperature of use can be very strong but can also be very rigid and potentially prone to fracture. Such foams also typically take a long time to recover to their original shape if compressed or dented. This can be less preferred if the intent is to have the foam expand against the housing to prevent leaks. Suitably, foams according to the present invention have a Tg between about −40° C. and about 90° C., preferred are foams having a Tg of from about −10° C. to about 50° C. More preferred are foams having a Tg of from about 0° to about 30° C.

D. Foam Composite Tensile Properties

The tensile strengths of the foam composites of the present invention are generally measured by clamping a thin strip using the jaws of an Instron tensile tester® or other appropriate device. The jaws are then separated at a standard rate at a fixed temperature and the force needed to effect this separation is measured and plotted as stress on the y-axis against strain on the x-axis to provide a stress-strain plot. The tensile strength is taken as the stress at failure. The area under the curve to the point of failure is taken as the toughness of the sample. The specifics of the measurement methodology used in the present case are described in more detail in the Experimental Section (infra).

Without being bound by theory, it is believed that compatible fibers provide improved tensile properties to the composite foams of the present invention by limiting the stretch of the composite to a value less than would be predicted by the Tg of the cured HIPE. Ultimate tensile strength is believed to be defined by a combination of adhesion of the HIPE foam to the fiber and the ultimate tensile strength of the cured HIPE. This combination is believed to result in improved modulus values without a corresponding reduction in foam softness.

E. Foam Composite Density

Another important property of the foam composites of the present invention is their density. “Foam density” (i.e., in milligrams of foam per cubic centimeter of foam volume in air) is specified herein on a dry basis unless otherwise indicated. Any suitable gravimetric procedure that will provide a determination of mass of solid foam material per unit volume of foam structure can be used to measure foam density. For example, an ASTM gravimetric procedure described more fully U.S. Pat. No. 5,387,207 (Dyer et al), issued Feb. 7, 1995, incorporated by reference herein, is one method that can be employed for density determination. While foams can be made with virtually any density ranging from below that of air to just less than the bulk density of the polymer from which it is made, the foams of the present invention are most useful when they have a dry density in the expanded state of less than about 100 mg/cc, preferably between about 77 and about 12 mg/cc, more preferably between about 63 and 32 mg/cc, and most preferably about 50 mg/cc. Note that for HIPE foams, the dry density can be approximated from the W:O ratio as 1/(W:O+1). For foam composites, the contribution to the density conferred by the added fiber much be included in this calculation.

II. Preparation of HIPE Foams

A. In General

Suitable processes for preparing the foams of the present invention are described in U.S. Pat. No. 5,149,720, issued Sep. 22, 1992 to DesMarais et al. and in U.S. Pat. 5,827,909 (DesMarais), issued on Oct. 27, 1998, the disclosure of each of which is incorporated by reference. Polymeric foam composites useful in the present invention are prepared by polymerization of HIPEs containing dispersed fibers therein. The relative amounts of the water and oil plus fiber phases used to form the HIPEs are used to control the density of the Is resulting HIPE foam composite. To be clear, the density of a normal HIPE foam is largely controlled by the water-to-oil (W:O) ratio of the preceding emulsion. In the foam composites of the present invention, the density is further increased by inclusion of the fiber.

The emulsions used to prepare the HIPE foams will generally have a volume to weight ratio of water phase to oil phase of at least about 4:1, preferably at least about 10:1, more preferably at least about 15:1, and still more preferably at least about 20:1. The ratio preferably ranges between about 12:1 and about 80:1, more preferably between about 15:1 and about 30:1.

The process for obtaining these foams comprises the steps of:

A. forming a water-in-oil emulsion using low shear mixing from:

(1) a polymerizable oil phase;

(2) a water phase comprising from about 0.1% to about 20% by weight of a water-soluble electrolyte; and

B. a volume to weight ratio of water phase to oil phase of less than about 100:1; and

C. mixing into the formed emulsion a level of about 1% to about 50% compatible fiber to achieve the desired level of homogeneity and dispersity; and

D. polymerizing the monomer component in the oil phase of the water-in-oil emulsion to form the polymeric foam material.

The foam composite can be subsequently iteratively washed, dewatered, And dried to provide a dry foam composite. The composite foam may be shaped as desired (e.g., by molding as described in the aforementioned provisional U.S. Patent application Ser. No. 60/167,213). In general, the fiber is added with mixing to the already formed HIPE though it can be added prior to formation of the emulsion as appropriate. Foam composites may also be prepared using modified continuous processing schemes such as are described in U.S. Pat. No. 5,209,430 to DesMaris et al. wherein the fiber is added continuously to the forming continuous HIPE stream prior to curing.

1. Oil Phase Components

The continuous oil phase of the HIPE comprises monomers that are polymerized to form the solid foam structure. This monomer component is formulated to be capable of forming a copolymer having a Tg of from about −40° to about 90° C., and preferably from about −10° to about 50° C., more preferably from about 0° to about 30° C. This monomer component includes: (a) at least one monofunctional monomer whose atactic amorphous polymer has a Tg of about 25° C. or lower (see Brandup, J.; Immergut, E. H. “Polymer Handbook”, 2nd Ed., Wiley-Interscience, New York, N.Y., 1975, 111-139.), (b) at least one polyfunctional crosslinking, and (c) an optional monomer. Selection of particular types and amounts of monofunctional monomer(s) and comonomer(s) and polyfunctional cross-linking agent(s) can be important to the realization of absorbent HfPE foams and foam composites having the desired combination of structure and thermomechanical properties which render such materials suitable for the uses described herein.

The monomer component that tends to impart rubber-like or low Tg properties to the resulting foam composite can, when used alone, produce high molecular weight (greater than 10,000) atactic amorphous polymers having Tgs of about 25° C. or lower. A nonlimiting list of monomers of this type includes the C₄-C₁₄ alkyl acrylates such as butyl acrylate, hexyl acrylate, octyl acrylate, 2-ethylhexyl acrylate, nonyl acrylate, decyl acrylate, dodecyl (lauryl) acrylate, isodecyl acrylate, tetradecyl acrylate; aryl and alkaryl acrylates such as benzyl acrylate and nonylphenyl acrylate; the C₆-C₁₆ alkyl methacrylates such as hexyl methacrylate, octyl methacrylate, nonyl methacrylate, decyl methacrylate, isodecyl methacrylate, dodecyl (lauryl) methacrylate, and tetradecyl methacrylate; acrylamides such as N-octadecyl acrylamide; C₄-C₁₂ alkyl styrenes such as p-n-octylstyrene; and combinations of such monomers. Of these monomers, isodecyl acrylate, dodecyl acrylate and 2-ethylhexyl acrylate are the most preferred. The monofunctional monomer(s) will generally comprise 10 to about 70%, more preferably from about 50 to about 60%, by weight of the monomer component.

The monomer component also contains at least one polyfunctional crosslinking agent. As with the monofunctional monomers and comonomers, selection of the particular type and amount of crosslinking agent(s) is important to the eventual realization of preferred polymeric foams having the desired combination of structural and mechanical properties. The polyfunctional crosslinking agent can be selected from a wide variety of monomers containing two or more activated vinyl groups, such as divinylbenzenes and analogs thereof. Analogs of divinylbenzenes useful herein include, but are not limited to, trivinyl benzenes, divinyltoluenes, divinylxylenes, divinylnaphthalenes divinylalkylbenzenes, divinylphenanthrenes, divinylbiphenyls, divinyldiphenylmethanes, divinylbenzyls, divinylphenylethers, divinyldiphenylsulfides, divinylfurans, divinylsulfide, divinylsulfone, and mixtures thereof. Divinylbenzene is typically available as a mixture with ethyl styrene in proportions of about 55:45. These proportions can be modified so as to enrich the oil phase with one or the other component. It may be advantageous to enrich the mixture with the ethyl styrene component while simultaneously reducing the amount of styrene in the monomer blend. The preferred ratio of divinylbenzene to ethyl styrene is from about 30:70 to 55:45, most preferably from about 35:65 to about 45:55. The crosslinking agent can also be selected from polyfunctional acrylates selected from the group consisting of diacrylates and dimethacrylates of diols, triols, and analogs thereof. Such crosslinking agents include methacrylates, acrylamides, methacrylamides, and mixtures thereof. These include di-, tri-, and tetra-acrylates, as well as di-, tri-, and tetra-methacrylates, di-, tri-, and tetra-acrylamides, as well as di-, tri-, and tetra-methacrylamides; and mixtures of these crosslinking agents. Suitable acrylate and methacrylate crosslinking agents can be derived from diols, triols and tetraols that include 1,10-decanediol, 1,8-octanediol, 1,6-hexanediol, 1,4-butanediol, 1,3-butanediol, 1,4-but-2-enediol, ethylene glycol, diethylene glycol, trimethylolpropane, pentaerythritol, hydroquinone, catechol, resorcinol, triethylene glycol, polyethylene glycol, sorbitol and the like. The acrylamide and methacrylamide crosslinking agents can be derived from the equivalent diamines, triamines and tetramines. Such crosslinking agents may also contain a mixture of acrylate and methacrylate moieties.

The monomer component also may contain at least one additional comonomer type intended to modify the properties of the foam composite. One type of comonomer includes those added to confer additional toughness to the resulting foam composite. Exemplary of such comonomers are styrene and ethyl styrene and homologs thereof. Another type of comonomer is intended to confer a degree of flame retardancy as disclosed in U.S. Pat. No. 6,160,028 issued Dec. 12, 2000 to Dyer et al. Other potential comonomers are well known to those skilled in the art and include generally water insoluble reagents including methyl methacrylate, chloroprene, 4-chlorostyrene, vinyl pyridine, vinyl pyrrolidinone, vinyl aniline, vinyl anisole, vinyl chloride, t-butyl acrylate, and the like.

The major portion of the oil phase of the HIPEs will comprise the aforementioned monomers, comonomers and crosslinking agents. It is essential that these monomers, comonomers and crosslinking agents be substantially water-insoluble so that they are primarily soluble in the oil phase and not the water phase. Use of such substantially water-insoluble monomers ensures that HIPEs of appropriate characteristics and stability will be realized. It is, of course, highly preferred that the monomers, comonomers and crosslinking agents used herein be of the type such that the resulting polymeric foam is suitably non-toxic and appropriately chemically stable. These monomers, comonomers and cross-linking agents should preferably have little or no toxicity if present at very low residual concentrations during post-polymerization foam processing and/or use.

Another essential component of the oil phase of the HIPE is an emulsifier component that comprises at least a primary emulsifier. Suitable primary emulsifiers are well known to those skilled in the art. The emulsifier is generally included in the oil phase and tends to be relatively hydrophobic in character. (See for example Williams, J. M., Langmuir 1991, 7, 1370-1377, incorporated herein by reference.) For preferred HMPEs that are polymerized to make polymeric foams, suitable emulsifiers can include sorbitan monoesters of branched C₁₆ -C₂₄ fatty acids, linear unsaturated C₁₆ -C₂₂ fatty acids, and linear saturated C₁₂ -C₁₄ fatty acids, such as sorbitan monooleate, sorbitan monomyristate, and sorbitan monoesters derived from coconut fatty acids. Particularly preferred emulsifiers include Span 20™, Span ₄₀™, Span ₆₀™, and Span 80™ as are available from ICI Surfactants of Wilmington, Del. These are nominally esters of sorbitan derived from lauric, myristic, stearic, isostearic, and oleic acids, respectively. Other preferred emulsifiers include: sorbitan isostearate available as Crill 6 from Croda, Inc. of Parsippany, N.J. and the polyglycerol esters available from Lonza, Inc. as Polyaldo 2-1-IS. Other suitable emulsifiers include diglycerol esters that are derived from monooleate, monomyristate, monopalmitate, and monoisostearate acids. Mixtures of these emulsifiers are also particularly useful, as are purified versions of each, specifically sorbitan esters containing minimal levels of isosorbide and polyol impurities. Exemplary emulsifiers include sorbitan monolaurate (e.g., SPAN® 20, preferably greater than about 40%, more preferably greater than about 50%, most preferably greater than about 70% sorbitan monolaurate), sorbitan monooleate (e.g., SPAN® 80, preferably greater than about 40%, more preferably greater than about 50%, most preferably greater than about 70% sorbitan monooleate), diglycerol monooleate (e.g., preferably greater than about 40%, more preferably greater than about 50%, most preferably greater than about 70% diglycerol monooleate, or “DGMO”), diglycerol monoisostearate (e.g., preferably greater than about 40%, more preferably greater than about 50%, most preferably greater than about 70% diglycerol monoisostearate, or “DGMIS”), and diglycerol monomyristate (e.g., preferably greater than about 40%, more preferably greater than about 50%, most preferably greater than about 70% sorbitan monomyristate, or “DGMM). These diglycerol monoesters of branched Cl₆-C₂₄ fatty acids, linear unsaturated C₁₆-C₂₂ fatty acids, or linear saturated C₁₂-C₁₄ fatty acids, such as diglycerol monooleate (i.e., diglycerol monoesters of C18:1 fatty acids), diglycerol monomyristate, diglycerol monoisostearate, and diglycerol monoesters of coconut fatty acids; diglycerol monoaliphatic ethers of branched C₁₆-C₂₄ alcohols (e.g. Guerbet alcohols), linear unsaturated C₁₆-C₂₂ alcohols, and linear saturated C₁₂-C₁₄ alcohols (e.g., coconut fatty alcohols), and mixtures of these emulsifiers are particularly useful. See U.S. Pat. No. 5,287,207 (Dyer et al.), issued Feb. 7, 1995 (herein incorporated by reference) which describes the composition and preparation suitable polyglycerol ester emulsifiers and U.S. Pat. No. 5,500,451 (Goldman et al.) issued Mar. 19, 1996 (incorporated by reference herein), which describes the composition and preparation suitable polyglycerol ether emulsifiers. These generally may be prepared via the reaction of an alkyl glycidyl ether with a polyol such as glycerol. Particularly preferred alkyl groups in the glycidyl ether include isostearyl, hexadecyl, oleyl, stearyl, and other C₁₆-C₁₈ moieties, branched and linear. (The product formed using isodecyl glycidyl ether is termed “IDE” hereinafter and that formed using hexadecyl glycidyl ether is termed “HDE” hereinafter.) Another general class of preferred emulsifiers is described in U.S. Pat. No. 6,207,724 (Hird et al.) issued Mar. 27, 2001. Such emulsifiers comprise a composition made by reacting a hydrocarbyl substituted succinic acid or anhydride or a reactive equivalent thereof with either a polyol (or blend of polyols), a polyamine (or blend of polyamines) an alkanolamine (or blend of alkanol amines), or a blend of two or more polyols, polyamines and alkanolamines. One effective emulsifier of this class is polyglycerol succinate (PGS), which is formed from an alkyl succinate and glycerol and triglycerol. Many of the above emulsifiers are mixtures of various polyol functionalities which are not completely described in the nomenclature. Those skilled in the art recognize that “diglycerol”, for example, is not a single compound as not all of this is formed by “head-to-tail” etherification in the process.

Such emulsifiers and blends thereof are typically added to the oil phase so that they comprise between about 1% and about 20%, preferably from about 2% to about 15%, and more preferably from about 3% to about 12% thereof. For the current application, emulsifiers that are particularly able to stabilize HIPEs at high temperatures are preferred. Coemulsifiers may also be used to provide additional control of cell size, cell size distribution, and emulsion stability, particularly at higher temperatures (e.g., greater than about 65° C.). Exemplary coemulsifiers include phosphatidyl cholines and phosphatidyl choline-containing compositions, aliphatic betaines, long chain C₁₂-C₂₂ dialiphatic, short chain C₁-C₄ dialiphatic quaternary ammonium salts, long chain C₁₂-C₂₂ dialkoyl(alkenoyl)-2-hydroxyethyl, short chain C₁-C₄ dialiphatic quaternary ammonium salts, long chain C₁₂-C₂₂ dialiphatic imidazolinium quaternary ammonium salts, short chain C₁-C₄ dialiphatic, long chain C₁₂-C₂₂ monoaliphatic benzyl quaternary ammonium salts, the long chain C₁₂-C₂₂ dialkoyl(alkenoyl)-2-aminoethyl, short chain C₁-C₄ monoaliphatic, short chain C₁-C₄ monohydroxyaliphatic quaternary ammonium salts Particularly preferred is ditallow dimethyl ammonium methyl sulfate (DTDMAMS). Such coemulsifiers and additional examples are described in greater detail in U.S. Pat. No. 5,650,222, issued in the name of DesMarais, et al. on Jul. 22, 1997, the disclosure of which is incorporated herein by reference. Exemplary emulsifier systems comprise 6% PGS and 1% DTDMAMS or 5% IDE and 0.5% DTDMAMS. The former is found useful is forming smaller celled HIPEs and the latter tends to stabilize larger celled HIPEs. Higher levels of any of these components may be needed for stabilizing HIPEs with higher W:O ratios, e.g., those exceeding about 35:1.

A particularly preferred emulsifier is described in copending U.S. Pat. No. 6,207,724 to Hird, et al. on Mar. 27, 2001. Such emulsifiers comprise a composition made by reacting a hydrocarbyl substituted succinic acid or anhydride or a reactive equivalent thereof with either a polyol (or blend of polyols), a polyamine (or blend of polyamines) an alkanolamine (or blend of alkanol amines), or a blend of two or more polyols, polyamines and alkanolamines. The lack of substantial carbon-carbon unsaturation rendering them substantially oxidatively stable.

In addition to these primary emulsifiers, secondary emulsifiers can be optionally included in the emulsifier component. Again, those skilled in the art well recognize that any of a variety of known emulsifiers may be used. These secondary emulsifiers are at least cosoluble with the primary emulsifier in the oil phase. Secondary emulsifiers can be obtained commercially or prepared using methods known in the art. The preferred secondary emulsifiers are ditallow dimethyl ammonium methyl sulfate and ditallow dimethyl ammonium methyl chloride. When these optional secondary emulsifiers are included in the emulsifier component, it is typically at a weight ratio of primary to secondary emulsifier of from about 50:1 to about 1:4, preferably from about 30:1 to about 2:1.

As is indicated, those skilled in the art will recognize that any suitable emulsifier(s) can be used in the processes for making the foams of the present invention. For example, See U.S. Pat. 5,387,207 (Dyer et al.) issued Feb. 7, 1995 and 5,563,179 (Stone et al.) issued Oct. 8, 1996, both of which are incorporated herein by reference.

The oil phase used to form the HIPEs comprises from about 80 to about 98% by weight monomer component and from about 2 to about 20% by weight emulsifier component.

Preferably, the oil phase will comprise from about 90 to about 97% by weight monomer component and from about 3 to about 10% by weight emulsifier component. The oil phase also can contain other optional components. One such optional component is an oil soluble polymerization initiator of the general type well known to those skilled in the art, such as described in U.S. Pat. No. 5,290,820 (Bass et al), issued Mar. 1, 1994, which is incorporated herein by reference. Other optional components include antioxidants such as a Hindered Amine Light Stabilizer (HALS) such as bis-(1,2,2,5,5-pentamethylpiperidinyl) sebacate (Tinuvin-765®) or a Hindered Phenolic Stabilizer (HPS) such as Irganox−1076® and t-butylhydroxy-quinone. Another optional component is a plasticizer such as dioctyl azelate, dioctyl sebacate, dioctyl adipate, or dioctyl phthalate, or the dinonyl homologs thereof. Other optional components include fillers, dyes, pigments, optical brighteners, other fluorescers, and other additives well known for use in modifying the properties of polymers.

2. Water Phase Components

The discontinuous water internal phase of the HIPE is generally an aqueous solution containing one or more dissolved components. One essential dissolved component of the water phase is a water-soluble electrolyte. The dissolved electrolyte minimizes the tendency of monomers, comonomers, and crosslinkers that are primarily oil soluble to also dissolve in the water phase. This, in turn, is believed to minimize the extent to which polymeric material fills the cell windows at the oil/water interfaces formed by the water phase droplets during polymerization. Thus, the presence of electrolyte and the resulting ionic strength of the water phase is believed to determine whether and to what degree the resulting preferred polymeric foams can be open-celled.

Any electrolyte capable of imparting sufficient ionic strength to the water phase can be used. Preferred electrolytes are mono-, di-, or trivalent inorganic salts such as the water-soluble halides, e.g., chlorides, nitrates and sulfates of alkali metals and alkaline earth metals. Examples include sodium chloride, calcium chloride, sodium sulfate and magnesium sulfate. Calcium chloride is the most preferred for use in preparing the HIPEs. Generally the electrolyte will be utilized in the water phase of the HIPEs in a concentration in the range of from about 0.2 to about 20% by weight of the water phase. More preferably, the electrolyte will comprise from about 1 to about 10% by weight of the water phase.

The HIPEs will also typically contain an effective amount of a polymerization initiator.

Such an initiator component is generally added to the water phase of the HIPEs and can be any conventional water-soluble free radical initiator. These include peroxygen compounds such as sodium, potassium and ammonium persulfates, hydrogen peroxide, sodium peracetate, sodium percarbonate and the like, as well as azo compounds. Conventional redox initiator systems can also be used. Such systems are formed by combining the foregoing peroxygen compounds with reducing agents such as sodium bisulfite, L-ascorbic acid or ferrous salts.

The initiator can be present at up to about 20 mole percent based on the total moles of polymerizable monomers present in the oil phase. More preferably, the initiator is present in an amount of from about 0.001 to about 10 mole percent based on the total moles of polymerizable monomers in the oil phase.

B. Processing Conditions for Obtaining Composite Foams

Foam preparation typically involves the steps of: 1) forming a stable high internal phase emulsion (HIPE); dispersing compatible fibers therein; 3) polymerizing/curing this stable emulsion under conditions suitable for forming a solid polymeric foam structure; 4) optionally washing the solid polymeric foam structure to remove the original residual water phase, emulsifier, any loosely held fiber, and salts from the polymeric foam structure and/or to treat the surface with a new material, and 5) thereafter dewatering this polymeric foam structure.

1. Formation of HIPE

The HIPE is formed by combining the oil and water phase components in the previously specified ratios. The oil phase will typically contain the requisite monomers, comonomers, crosslinkers, and emulsifiers, as well as optional components such as plasticizers, antioxidants, flame retardants, pigments, dyes, fillers, and chain transfer agents. The water phase will typically contain electrolytes and polymerization initiators.

The HIPE can be formed from the combined oil and water phases by subjecting these combined phases to shear agitation. Shear agitation is generally applied to the extent and for a time period necessary to form a stable emulsion. Such a process can be conducted in either batch or continuous fashion and is generally carried out under conditions suitable for forming an emulsion where the water phase droplets are dispersed to such an extent that the resulting polymeric foam will have the requisite structural characteristics. Emulsification of the oil and water phase combination will frequently involve the use of a mixing or agitation device such as a pin impeller. If the fibers are to be added after formation of the HIPE, they will generally be introduced with sufficient but minimal shear so as to disperse the fibers without radically changing the microstructure of the already formed HIPE.

One preferred method of forming HIPE involves a continuous process that combines and emulsifies the requisite oil and water phases. In such a process, a liquid stream comprising the oil phase is formed. Concurrently, a separate liquid stream comprising the water phase is also formed. The two separate streams are then combined in a suitable mixing chamber or zone such that the requisite water to oil phase weight ratios previously specified are achieved.

In the mixing chamber or zone, the combined streams are generally subjected to shear agitation provided, for example, by a pin impeller of suitable configuration and dimensions. Shear will typically be applied to the combined oil/water phase stream at an appropriate rate. Once formed, the stable liquid HIPE can then be withdrawn from the mixing chamber or zone. This preferred method for forming HIPEs via a continuous process is described in greater detail in U.S. Pat. No. 5,149,720 (DesMarais et al), issued Sep. 22, 1992 and U.S. Pat. No. 5,827,909 (DesMarais et al.) issued Oct. 28, 1997, both of which are incorporated by reference.

An alternate preferred method is described in U.S. patent application Ser. No. 09/684,037, entitled “Apparatus and Process for In-Line Preparation of HIPEs”, filed in the name of Catalfamo, et al. on Oct. 6, 2000. The method forms high internal phase emulsion (HIPE) using a single pass through the static mixer. In alternative embodiments, the HIPE may be further processed to further modify the size of dispersed phase droplets, to incorporate additional materials into the HIPE, to alter emulsion temperature, and the like.

2. Fiber Addition

Fiber addition may be performed prior to, during, or after formation of the HIPE. It must be done before any significant curing occurs. Fibers may be added as part of the oil or aqueous phases and dispersed during emulsification. Fibers may be metered in during the mixing phase of emulsification. Fibers may also be added after formation of the emulsion prior to curing with additional mixing. Fibers may be added as dry loose materials or suspended or slurried with another liquid phase.

It is important that the fibers be evenly distributed throughout the HIPE so the resulting composite has substantially isotropic mechanical properties. Fibers should be sufficiently dispersed so as to minimize residual fiber clumps. Dispersion of the fibers evenly throughout the HIPE may be accomplished by any mixing means as may be known to those skilled in the art. Suitable mixing means depend on the point of fiber addition and include: rotary mixers, in-line mixers, static mixers, and the like. Any additional mixing after initial HIPE formation will provide additional shear energy and tend to form emulsions with smaller cell sizes so it may be necessary to adjust HIPE formation conditions.

3. Curing of the HIPE

The HIPE-fiber mixture formed will next be polymerized and crosslinked (i.e., cured). In one embodiment, the HIPE will be collected in a curing vessel comprising a tub constructed of polyethylene from which the eventually cured solid foam material can be easily removed for further processing after curing has been carried out to the extent desired. Alternatively, the HIPE may be cured continuously as described for example in PCT application WO 00/50498 to DesMarais et al., published Aug. 31, 2000. The temperature at which the HIPE is poured into the vessel is preferably approximately the same as the curing temperature.

Suitable curing conditions will vary depending upon the monomer and other makeup of the oil and water phases of the emulsion (especially the emulsifier systems used), and the type and amounts of polymerization initiators used. Frequently, however, suitable curing conditions will involve maintaining the HIPE at elevated temperatures above about 30° C., more preferably above about 45° C., for a time period ranging from about 2 to about 64 hours, more preferably from about 4 to about 48 hours. The HIPE can also be cured in stages such as described in U.S. Pat. No. 5,189,070 (Brownscombe et al.), issued Feb. 23, 1993, which is herein incorporated by reference.

A porous water-filled open-celled HIPE foam is typically obtained after curing in a reaction vessel, such as a tub. This cured HIPE foam may be cut or sliced into a sheet-like form. Sheets of cured HIPE foam are easier to process during subsequent treating/washing and dewatering steps. The cured HIPE foam is typically cut/sliced to provide a cut thickness in the range of from about 1 mm to about 10 mm. Such sheets may be wound into a cylinder to form the shape needed for the filter housing. Alternatively, the HIPE may be poured into a mold cavity having the same shape as is used in forming a filter, and optionally a little larger than the final housing). It is preferred that the mold cavity have a HIPE-compatible such as glass, Mylar, polycarbonate, or polyurethane.

4. Treating/Washing the Foam Composite

The polymerized foam composite formed will generally be saturated with residual water phase material used to prepare the HIPE. This residual water phase material (generally an aqueous solution of electrolyte, residual emulsifier, and polymerization initiator) is generally removed prior to further processing and use of the foam. Removal of this original water phase material will usually be carried out by compressing the foam structure to squeeze out residual liquid and/or by washing the foam structure with water or other aqueous washing solutions. Frequently several compressing and washing steps, e.g., from 2 to 4 cycles, can be used. Following each stage of compressing, a new aqueous solution containing any of several adjuvants may be reapplied to the foam composite.

5. Foam Composite Dewatering

After the HIPE foam has been treated/washed, it will be dewatered. Dewatering can be achieved by compressing the foam to squeeze out residual water, by subjecting the foam, or the water therein to temperatures of from about 60° to about 200° C. or to microwave treatment, by vacuum dewatering or by a combination of compression and thermal drying/microwave/vacuum dewatering techniques. The dewatering step will generally be carried out until the HIPE foam is ready for use and is as dry as practicable. Frequently such compression dewatered foams will have a water (moisture) content as low as possible, from about 1% to about 15%, more preferably from about 5% to about 10%, by weight on a dry weight basis. During or after this step, additional adjuvants for modifying the surface of the foam composite may be applied.

III. Exemplary Foam Composite Uses

A. Filtration

The foam composites according to the present invention are broadly useful for filtering fluids, including water and aqueous media. These foam composites can be provided in various shapes such as cylinders, cubes, sheets, plugs, particulates, and irregular or customized shapes. If a rigid foam is desired, the foams would comprise those formulations which yield a relatively high Tg, from about 30° to about 90° C. (While foam composites having Tgs exceeding about 90° C. are contemplated, such foam composites would be difficult to process in terms of removing of excess water by squeezing.) A flexible foam would comprise those formulations which yield a lower Tg, from about −40° C. to about 30° C. These Tg ranges presume a use temperature near room temperature and would be adjusted as necessary so the foam is suitable for applications at lower or higher uses temperatures to achieved the desired stiffness level.

These foam composites are readily conformable to a filter body casing. They may thus be formed slightly larger than any rigid casing to prevent gaps or openings. The foam composites of this invention may be laminated or bonded to other support media to provide stiffness, strength, durability, or better filtration properties. Such support media for example include nonwoven and woven materials, meshes, ceramic and glass frits, plastic screens, films, other foams, other fibers, and other types of generally porous compatible structures.

The specific filter design may be varied widely as is known to those skilled in the art to include, for example, a prefilter to remove larger particulate contaminate may be employed so as to prevent premature clogging of the primary filter element. The prefilter may comprise a HIPE foam having larger cell sizes or may be a standard nonwoven or open-celled foam filter. The prefilter may also comprise a segment of an integral HIPE derived foam piece wherein the upper portion has relatively large cells and the lower portion has relatively small cells. Such heterogeneous HIPE derived foams are described generally in the aforementioned U.S. Pat. No. 5,817,704 (Shiveley et al.) issued Oct. 6, 1998. Other filtration elements which may be incorporated into a filter design include materials such as activated carbon or charcoal, zeolites, nonwoven filters, sand, and the like.

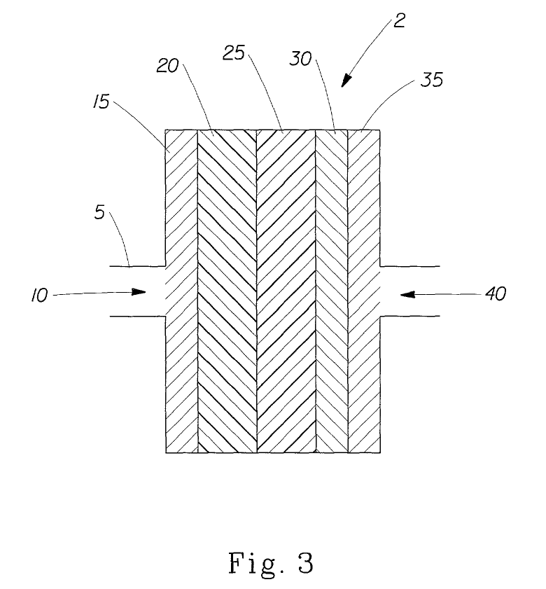

An exemplary assembly 2 that is suitable for use as a filtration device that uses the HIPE foams of the present invention is shown in FIG. 3. The assembly 2 comprises a casing 5 for containing the other assembly elements. The casing 5 provides an enclosed volume with interior wall surfaces that surrounds the other filter elements. The casing may have any desired shape as may be necessary for a particular use. Suitable shapes include, but are not limited to cylindrical, rectangular, irregular, and any other shape as may be necessary for a particular use. The enclosed volume is also defined by the ultimate use of the filtration assembly 2, particularly the desired flow rate therethrough. The casing 5 is breached by an inlet port 10 where water to be treated enters the device and an exit port 40 where the treated water leaves the device. The entry and exit ports 10, 40 may be designed with screw-type attachments convenient for accepting standard hoses or pipes or other means as may be known to the art for attaching means to supply and remove the liquid to be filtered. Alternatively, the ports may be designed so that the entry port is attachable to a holding tank or reservoir into which untreated water or liquid is poured.

The assembly 2 further comprises one or more of the following elements that are disposed between the inlet port 10 and the exit port 40 and sealed against the walls thereof. The elements including at least one element comprising a HIPE foam that is treated to have biocidal properties. Untreated water entering the assembly 2 through inlet port 10 first encounters a prefilter 15 that is suitable for removing larger particulate contaminants. Nonwoven materials are particularly suitable for use as a prefilter 15. In the embodiment of the assembly 2 shown in FIG. 1, the assembly 2 comprises a first HIPE foam filter element 20 and a second HIPE foam filter element 25. Typically, the first HIPE foam element 25 will have a larger mean cell size than the second HIPE foam filter element 30. The second HIPE foam filter element 30 is also treated so as to have biocidal properties as described herein. The assembly 2 can also comprise one or more polishing filters 30 comprising materials such as activated carbon to remove organic contaminants or zeolites to remove metal ion contamination. Immediately upstream of the exit port 40 the assembly includes a filter packing element 35 to insure retention of other filter elements within the casing 5.

Composite foams of the present invention may also be used as filter media in water pitchers which comprise a holding vessel and a collection vessel. Water (or other liquid) to be treated is poured into the upper vessel and then passes through the filter body by force of gravity or artificial pressurization. The purified water is collected in the lower vessel for use.

Other devices for passing water effectively through the filter system of the present invention such as straws, pipes, tubes, conduits, troughs, cisterns, two-part canteens, hand-pumps, and the like are also envisioned. A portable device such as a straw could be particularly useful for travelers visiting areas wherein the water quality is not assured. Such a straw or other portable device could be substantially disposable after one or a few uses. Larger and more long-lasting filtration devices may be constructed for use in industrial water treatment where standard chlorination is not used for reasons of taste or quality. An example is the preparation of water for making canned or bottled beverages, including spring water, juices, beer, soft drinks, and the like. The composite foams of the present invention are generally efficient in removing organic contaminants from the aqueous fluid streams.

The art is replete with examples of water filters, including foam water filters combined with activated charcoal (see for example PCT Patent Application Ser. No. WO99/36172 (Allen) published Jul. 22, 1999, incorporated herein by reference). However, the integrity of the filter medium, the efficiency of pathogen removal, the ease of formation, and the low back pressure of filters formed with foam composites of the present invention are believed to be superior because of the unique combination of benefits provided by the composite foams of the present invention.

The foam composites of the present invention are also useful in filtering blood. For example, the foam composites can be designed to remove the erythrocytes from blood efficiently while passing the serum. The foam composites may also be used as part of a diagnostic device wherein certain components of blood are removed prior to analysis. Examples of filters for blood are well known in the art but do not comprise use of the foam composites of the present invention. See for example U.S. Pat. No. 5,190,657 (Hengle et al.) issued Mar. 2, 1993, U.S. Pat. No. 5,456,835 (Castino et al.) issued Oct. 10, 1995, and U.S. Pat. No. 5,186,843 (Baumgardner et al.) issued Feb. 16, 1993, each of which being incorporated herein by reference.

B. Gas Filtration and Adsorption

The passage of a gas, such as contaminated air, through a foam composite of the present invention, particularly those containing ACF, results in substantial removal of more polar gases, which includes those which are malodorous and/or toxic gas. The foam composites of the present invention also efficiently filter fine particulate contaminants from the air. Without being bound by theory, it is believed that a fiber, particularly an ACF, removes chemical contaminants by chemical or physical adsorption processes due to the high surface area of the fiber. Odiferous gases (which are typically more polar) tend to displace the less polar air molecules (oxygen, nitrogen, argon) initially adsorbed on the surface of the fiber. Thus, the foam composite of the present invention when the composition comprises ACFs is particularly useful as part of an air purification or malodor removal unit or device.

Fine particulates may be removed by the foam composite via interception, impaction, and/or adsorption mechanisms. In these cases, the added fiber may increase the tortuosity of the pathway the fluid follows through the foam. See for example FIG. 1 which clearly shows the extension of the ACFs into the cell microstructure.

Many uses for such a filter are envisioned. As an example, the foam composite of the present invention may comprise a portion of a face mask or respirator for wearing in contaminated air conditions. When the foam composite of the present invention is combined with a fan or other device for moving air with appropriate ducting, the resulting device is useful for removing malodors common in areas such as bathrooms, kitchens, restaurants, basements, outbuildings, manufacturing buildings, in air handling and ventilation and cooling/heating systems in commercial and residential buildings, in laboratory or production places using volatile chemicals, military items such as bases, armored fighting vehicles, airplanes, submarines, space vehicles, and portable respirators for removing poison gases and radioactive particles encountered in combat conditions or fire fighting and the like. Such devices may also serve as part of a stand alone device for providing general area air purification and removal of malodors. Composite foams of the present invention may be used for adsorbing and/or trapping fuel vapors as part of a fuel canister recovery system or positive crankcase ventilation filters such as are used on automobiles and trucks. The composites of the present invention generally are useful in adsorbing volatile amines, thiols, unburned hydrocarbons, soot, as from diesel or other combustion engine exhaust, oxides of nitrogen, ozone, formaldehyde, sewer gas (which largely comprises thiols), gasoline, methyl t-butyl ether, and other fuel vapors, and the like from air.

The ability of the composite to adsorb or otherwise remove malodors is also useful in personal absorbent products including baby diapers, adult incontinence briefs, sanitary napkins and tampons, and for other implements intended to collect and store body exudates. The malodors associated with such wastes which include various amines such as skatole, cadaverine, putracine, and other compounds such as urea derivatives may be adsorbed by the composites.

Similarly, a layer may be used as part of a garbage bag for storing waste which is or can become malodorous, including kitchen waste and yard waste (such as grass clippings). A specific example is a garbage bag comprising polyethylene plies having a layer of the HIPE foam-ACF composite at the bottom or side of the bag. The composite may further be treated so as to be hydrophilic so that it can absorb and immobilize free fluid thus preventing spills in the event that the integrity of the bag is compromised. The composites may also serve as part of “body bags” and caskets and other conveyances for corpses which may decay over time and release exudates and malodorous volatile gases. A layer of composite of the present invention may be used as part of a composting device to remove the malodorous gases often produces by adventitious anaerobic biodegradation of plant waste.

The foam composites of the present invention may be electrostatically charged as described generally in Lamb, G.; Costanza, P. Textile Research J. 1977, 47(5), 372, incorporated herein be reference. Such “electret” type treatment is generally more useful in the filtration of gases than liquids.

C. Floor Mats, Shoe Inserts, Protective Covers and Other Implements

The foam composites of the present invention are found generally to exhibit superior durability relative to HIPE foams of the same formulation and density. This attribute is particularly useful for applications wherein the durability of the foam is required to be of a high level. Further, the foam composites of the present invention may be tinted in degrees having a gray coloration. This feature which tends to hide dirt rubbed off on the surface of the item, thus prolonging its period of acceptability before it begins to appear excessively dirty or used. The malodor adsorption properties of the foam composites is also advantageous in many of these applications.

A nonlimiting list of exemplary applications for the composites of the present invention as implements includes use as floor mats (see for example U.S. Pat. No. 5,245,697 to Conrad et al., issued Jun. 12, 2001,) shoe and boot insoles, underarm pads, pads for use in athletic activities (wherein the combination of protective cushioning, sweat absorption, body odor adsorption, light weight, and flexibility associated with the composites of the present invention may be of particular utility), shelf liner for refrigerators, food storage areas such as pantries, and the like, oil sorbent mats for use in automobile repair shops and restaurant food preparation areas, particularly where frying is conducted, automobile seat and floor covers, place mats for dining, mats for placement in pet areas, under high chairs, under pet food and water bowls, in children's work areas, as a protective cover beneath potentially incontinent people and animals, as a liner within an insulating vessel (wherein the combination of malodor adsorption and thermal insulating properties may be of particular utility, infra) such as a cooler or beverage container or cooling appliance, as casket linings, as covers for construction areas to protect a surface from tracked dirt, sawdust, paint spills, and the like, sponges for cleaning purposes, wipes for cleaning purposes, in laboratories and chemical manufacturing operations for cushioning and for absorbing chemical spills, in boats, planes and trains, as protective covers, and for other related uses. The ability of such composites to adsorb malodorous gases from the air while also absorbing fluids such as water and organic solvents, providing protective cushioning and thermal/acoustic insulation, is of particular value in many of these applications. When used as a floor mat in a chemical manufacturing area, for example, the composites of the present invention provide for less worker fatigue by cushioning, protection of the underlying surface, in-place chemical absorption capacity, an attractive appearance, durability, dirt trapping and masking ability, and other useful attributes.

D. Thermal Insulation

The foam composites of the present invention that contain fibers that absorb or block the transmission of infrared radiation will increase the insulation efficiency of the material. This can also be achieved by inclusion of particulate carbonaceous material, as disclosed in U.S. Patent No. 5,633,291 (Dyer et al.) issued May 27, 1997. However, such particulates exhibit generally poor retention with in the HIPE foam structure. For example, HIPE foams made with even low level loadings of carbon black or graphitic fillers exhibit very poor hygiene and release the fine particles upon contact or manipulation of any kind. Anything that comes into contact with the HIPE foam becomes covered with a black, carbonaceous coating. In contrast, the fibers of the present invention are entangled within the HIPE foam network and generally are not liberated in any consequential amount even when the foam composite is cut, machined, pressed, rubbed, abraded, etc.

Foam composites of the present invention, particularly those containing fibers such as ACF or the non-activated carbon fiber counterpart, termed hereinafter as “NACF”, which are essentially opaque to infrared radiation, are particularly efficient thermal insulating materials and highly desirable for such applications. Other fibers, including mineral fibers, may be surface treated with a compound which absorbs broadly within the infrared range. Such fibers may also be manufactured to include carbonaceous material within the fiber matrix itself to add to the infrared absorption capabilities. Such fibers may also be generated by incorporating carbonaceous material into otherwise transparent fibers during extrusion of the fibers.

High efficiency thermal insulation is of great import in appliances such as refrigerators and freezers, clothing items, transportation vehicles, the manufacture of vacuum insulation panels (wherein the open-celled nature of the foam composites of the present invention is critical), and the like. Where necessary, such foam composites may be manufactured or treated to confer a degree of fire resistance needed for the application. Exemplary fire retardant treatments are disclosed in the aforementioned U.S. patent application Ser. No. 09/118,613. Incorporation of fibers such as mineral fibers and the like which do not bum can contribute to reducing the flammability of the foam composites of the present invention.

E. Personal Absorbent Products

The foam composites of the present invention, especially when treated so as to be hydrophilic (infra), may serve as useful components of absorbent products including such articles as baby diapers and training pants, feminine protection pads and tampons, articles for incontinent adults, bandages including Band-Aids, athletic wraps, sweat bands, and the like. In such applications, the foam composites of the present invention serve both to absorb body exudates while also reducing any malodor that may arise during use of after disposal of such products. Descriptions of some of these uses for hydrophilic HIPE foams (though not foam composites of the present invention) are incorporated in more detail in U.S. Pat. No. 5,873,869 (Hammons et al.) issued Feb. 23, 1999, 5,1747,345 (Young et al.) issued Sep. 15, 1992, 5,632,737 (Stone et al.) issued May 27, 1997, and 5,268,224 (DesMarais et al.) issued Dec. 7, 1993, 5,795,921 (Dyer et al.) issued Aug. 18, 1998, and PCT Application Serial No. 98/43575 (Weber et al.) published Oct. 8, 1998, all of which are incorporated herein by reference.

F. Foam Composites Having Antimicrobial Surface Treatments

The composite of the present invention may be further treated with a substantive polymer coating which exerts biocidal activity. This can kill microorganisms which pass through or come into contact with the foam composite. This treatment can also prevent microbial growth while the foam composite is not in current use but is exposed to a source of microorganisms such as water from rivers, lakes, streams, and the like, sweat, blood, or other body exudates. A variety of substantive biocidal agents are known to those skilled in the art and may be employed. Exemplary are polymers having a biguanide moiety attached distally to the main chain of the polymer. The biguanide moiety is a good chelant for various metals which have biocidal activity, including silver, aluminum, zinc, zirconium, and the like. Especially preferred surface treatments include polyhexmethylene biguanide (PHMB) crosslinked with N,N-methylenebisdiglycidylaniline (MBDGA) and post-treated with silver iodide.

Also exemplary are foams made containing primary or secondary amine moieties subsequently treated with hypohalite or other halonium source to form N-haloamines. When exposed to water, these N-haloamines both provide biocidal activity and elute a low level of hypohalite into the water stream. Particularly preferred are hypohalites such as hypochlorite available commercially as chlorine bleach like Clorox™. When the chlorine content has dissipated, it can be regenerated by reexposing it to an aqueous hypohalite solution. Exemplary polymer coatings of general foams (but which may be generalized to include the foam composites of the present invention) are described in more detail in Ekonian et al. Polymer 1999, 40, 1367-1371, incorporated herein by reference.

Other biocidal treatments based on attached quaternary ammonium salts, quaternary phosphonium salts, halogenated sulfonamides, and other such treatments known to those skilled in the art may be applied, preferably using a method which at least semi-permanently attaches the agent to the foam composite.

G. Foam Composite Surface Wetting Treatments

The foam composite of the present invention may also be treated with a variety of agents intended to render the surface hydrophilic and potentiate the absorption of aqueous fluids. Such treatments generally comprise washing polymerized foam composites with wetting agents or surfactants well known to those skilled in the art but can also comprise certain chemical and physical treatments. In some cases, a slight residual level of a hygroscopic inorganic salt may be useful. Exemplary salt include calcium chloride and magnesium chloride. The levels of such salts will typically be between about 0.2% and 7% by weight of dry foam composite. Further exemplary wetting treatments are described in U.S. Pat. No. 5,352,711 (DesMarais) issued Oct. 4, 1994, 5,292,777 (DesMarais et al.) issued Mar. 8, 1994, and U.S. Pat. No. 5,849,805 (Dyer) issued Dec. 15, 1998, all of which are included herein by reference.

H. Other Attributes

The foam composites of the present invention may be manufactured in a variety of shapes and sizes. An example shape comprises a sheet-like structure which is essentially two dimensional with a thin cross-section. Exemplary is a mat 0.5 m by 0.8 m in the two dimensions and 2 mm in the third dimension. In sheet form, the foam composite may be manufactured as roll stock for delivery to an operation which converts it into a product.

The composites may also be manufactured in three dimensional shapes such as cylinders, cubes, and even more complex shapes. Since the emulsion will conform to the shape of the vessel into which it is poured for curing, essentially any shape which can be made as a mold can be adopted by the composite (i.e., as described in PCT application WO 00/50498 published Aug. 31, 2000. The foam composite may also be ground into smaller particles, cut into narrow sheets (akin to linguini), or made into cylinders of varying sizes ranging from “spaghetti” shapes to a meter or more in diameter.

The composite foam of the present invention may be manufactured containing any number of other adjuvants, including other fibers, nonwoven webs, other foams, chemicals such as antioxidants, dyes, pigments, opacifying agents, chain transfer agents, antimicrobial agents (supra), fluorescers, and the like. The composite foam may also contain a variety of filler particles include aluminum, titanium dioxide, carbon black, graphite, calcium carbonate, talc, ground rubber tires, and the like. These filler particles, in particular carbon black or activated carbon, are not well retained in the structure and will readily rub off with slight contact, unlike the fibers of the present invention.

The composite foam of the present invention may be laminated, backed, adhered to, or otherwise joined with another material such as a permeable or impermeable polymeric film, nonwoven, woven, metal foil, or other substrate for a variety of purposes. The foam of the present invention may also be comminuted into particulate form and the particulates may be enclosed within a fabric structure having a pouch or bag to surround the foam so as to provide integrity, the pouch material being permeable to air or water or not permeable as needed. Exemplary clothing includes: coats, gloves, sleeping bags, and other similar clothing items intended to protect the wearer from extremes of temperature.

IV. Test Methods

A. Dynamic Mechanical Analysis (DMA)

The process used for measuring the Tgs of the foam composites of the present invention using DMA is described in detail in U.S. Pat. No. 5,817,704 (Shiveley et al.) issued Oct. 6, 1998.

B. Tensile Strength

The tensile strength of the foam composite is measured using relatively thin strips (1.5 mm to 3 mm typically) shaped into a dogbone wherein the base of the dogbone shape is at least twice the width of the inner strip. The thicker base is used for securing the sample between clamps. The tensile measurement is conducted using a Rheometrics RSA 2 Dynamic Mechanical Analyzer using the fiber-film attachment. The foam composite dogbone strips are secured within the jaws and zero tensioned. The temperature of the test is set at 31° C. The stress-strain profile is selected from the menu using 0.1% strain per second as the rate. The data are then graphed as stress on the y-axis in Pascals and strain on the x-axis in % (of the full gap separation at the start of the experiment). Tensile strength is taken as the peak stress achieved before the sample fails under the tensile load. A similar test can be conducted using an Instron tester but a controlled temperature of the experiment is critical to achieving the same results.

C. Density

The method for measuring dry foam composite density is disclosed in U.S. Pat. No. 5,387,207 (Dyer et al.) issued Feb. 7, 1995.

D. Abrasion Resistance

Abrasion resistance represents the ability of the foam composite to resist tearing, abrading, pilling, or other forms of failure when subjected to surface stress, including torsional stress or normal stress. The best method defined for assessing abrasion resistance has been by subjective assessment by at least 4 individuals using blind comparative methods. Each assigns a grade of 1 through 5 wherein 1 reflects the highest degree of abrasion resistance and 5 reflects a grade given to a material which is destroyed with very little surface shear. The individual scores are averaged relative to a suitable control with the result reported.

E. Malodor Removal Efficiency from an Air Stream

Methyl mercaptan (CH₃SH) was chosen as the model odor compound. The ability of the foam composites of the present invention to remove this compound from a stream of gas flowing through it was studied. A 2-3 g sample of foam composite which had been comminuted into particulate (see Table 1) was packed into a glass tube. One end of the tube was connected to a permeation device which emitted a flow of 1.07 ppm CH₃SH (in air) at a rate of 100-300 mL/min (Metronics Model 340 Dynacalibrator, VICI Metronics Inc., Santa Clara, Calif.). The other end of the tube was connected to a PE Photovac photoionization detector (PE Photovac, Norwalk, Conn.). The response of the photoionization detector was monitored over time. Blank experiments were performed with glass wool packed inside the glass tube. All experiments were conducted at ambient temperature.

The parameter which characterizes the collection efficiency of the foam composite sorbent for a particular probe molecule is the sample capacity and breakthrough volume. The breakthrough volume is the volume of gas containing the probe that can be passed through the sorbent bed until its concentration at the outlet reaches a predetermined fraction of the inlet concentration.

V. Specific Examples

The following examples illustrate the preparation of foam composites useful in the present invention.

### Example 1

Preparation of Foam Composite from a HIPE

A) HIPE Preparation

The water phase is prepared consisting of 4% calcium chloride (anhydrous) and 0.05% potassium persulfate (initiator). The solution is heated to 50° C.

The oil phase is prepared according to the monomer ratios described in Table 1, all of which include an emulsifier for forming the HIPE. The preferred emulsifier used in these examples is diglycerol monooleate (DGMO) used at a level of 4-8% by weight of oil phase. The DGMO emulsifier (Grindsted Products; Brabrand, Denmark) comprises approximately 81% diglycerol monooleate, 1% other diglycerol monoesters, 3% polyglycerols, and 15% other polyglycerol esters, imparts a minimum oil phase/water phase interfacial tension value of approximately 2.5 dyne/cm and has a critical aggregation concentration of approximately 2.9 wt %.

To form the HIPE, the oil phase is placed in a 3” diameter plastic cup. The water phase is placed in a jacketed addition funnel held at about 50° C. The contents of the plastic cup are stirred using a Cafrano RZR50 stirrer equipped with a six-bladed stirrer rotating at about 300 rpm (adjustable by operator as needed). At an addition rate sufficient to add the water phase in a period of about 2 to 5 minutes, the water phase is added to the plastic cup with constant stirring. The cup is moved up and down as needed to stir the HIPE as it forms so as to incorporate all the water phase into the emulsion.

B. Fiber Incorporation

The desired amount and type of fiber is dispersed with stirring into the formed HIPE using the same mixer as is used to form the HIPE initially.

C. Polymerization/Curing of HIPE

The HIPE in the 3″ plastic cups are loosely capped and placed in an oven set at 65° C. overnight to cure and provide a polymeric HIPE foam.

D. Foam Washing and Dewatering

The cured foam composite is removed from the cup as a cylinder 3″ in diameter and about 4″ in length. The foam at this point has residual water phase (containing dissolved emulsifiers, electrolyte, initiator residues, and initiator) about 10−100 times the weight of polymerized monomers. The foam is sliced on a meat slicer to give circular pieces about 3 to about 8 mm in thickness. These pieces are washed in distilled water and compressed to remove the water 3 to 4 times.

The pieces are then dried in an oven set at 65° C. for 1 to 2 hours. In some cases, the foams collapse upon drying and must be freeze-dried from the water swollen state to recover fully expanded foams.

### Example 2

Foam composites using various monomer compositions, fiber types, and fiber levels were prepared generally as described in Example 1. The fibers are all compatible according to the present invention. Table 1 summarizes the compositions and Tg or these exemplary composite:

TABLE 1
Foam Composition

| Exam- | | | | | Fiber | | |
|---|---|---|---|---|---|---|---|
| ple | STY | DVB42 | EHA | HDDA | Percentage/ | W:O | Tg |
| # | % | % | % | % | Type | Ratio | (° C.) |
| 1a | 26.3 | 16.2 | 57.5 | 0 | 1%/ACF | 20:1 | 11 |
| 1b | 26.3 | 16.2 | 57.5 | 0 | 3%/ACF | 20:1 | 11 |
| 1c | 26.3 | 16.2 | 57.5 | 0 | 5%/ACF | 20:1 | 11 |
| 1d | 26.3 | 16.2 | 57.5 | 0 | 10%/ACF | 20:1 | 11 |
| 1e | 26.3 | 16.2 | 57.5 | 0 | 1%/NACF | 20:1 | 11 |
| 1f | 26.3 | 16.2 | 57.5 | 0 | 3%/NACF | 20:1 | 11 |
| 1g | 26.3 | 16.2 | 57.5 | 0 | 5%/NACF | 20:1 | 11 |
| 1h | 26.3 | 16.2 | 57.5 | 0 | 10%/NACF | 20:1 | 11 |
| 1i | 24 | 18 | 58 | 0 | 5%/ACF | 20:1 | 12 |
| 1j | 0 | 33 | 55 | 12 | 5%/ACF | 45:1 | 18 |
| 1k | 15 | 20 | 55 | 10 | 5%/ACF | 35:1 | 15 |
| 1l | 20 | 25 | 55 | 0 | 25%/INF | 25:1 | 23 |
| 1m | 20 | 25 | 55 | 0 | 25%/ACF | 25:1 | 25 |
| 1n | 20 | 25 | 55 | 0 | 25%/Minifiber | 25:1 | 22 |

STY = styrene; available from Aldrich Chemical Corp.
DVB = divinyl benzene of 42% purity with 58% ethyl styrene available from Dow Chemical Corp.
EHA = 2-ethylhexyl acrylate; available from Aldrich Chemical Corp.
HDDA = 1,6-hexanediol diacrylate; available from Aldrich Chemical Corp.
ACF = 0.2 mm length Activated Carbon Fibers obtained from Osaka Gas Chemical.
NACF = 0.2 mm length non-Activated Carbon Fibers obtained from Osaka Gas Chemical.
INF = Inorphil mineral fibers Lot 061-60 obtained from Fiberand Corp. of Miami, FL.
Minifiber = “Short Stuff ® polyethylene fiber available from Minifiber Inc. of Johnson City, TN.

Table 2 summarizes properties of exemplary comparative foam composites formed using incompatible fibers not of the present invention.

TABLE 2
Foam Composition.

| | | | | | | | Tensile | |
|---|---|---|---|---|---|---|---|---|
| Comparative | STY | DVB42 | EHA | HDDA | Fiber Level | W:O | Strength | Tg |
| Example # | % | % | % | % | and Type | Ratio | (Pa) | (° C.) |
| 2a | 20 | 15 | 55 | 0 | 0% | 25:1 | 2.7 × 10⁴ | 22° |
| 2b | 20 | 25 | 55 | 0 | 5% Crill^{a} | 25:1 | | 22° |
| 2c | 20 | 15 | 55 | 0 | 5% Oasis ™^{b} | 25:1 | | 22° |

^{a}Crill fibers are highly refined, high surface area cellulose pulp fibers having a Canadian Standard Freeness (CSF) of less than about 200. Stable HIPEs could not be formed using higher levels of the Crill fibers.
^{b}Oasis fibers are superabsorbent fibers based on sodium polyacrylate, available from Technical Absorbents Ltd. Of Grimsby, UK. The HIPE was immediately destabilized upon addition of these fibers.

Table 3 shows the effect on tensile properties of composite HIPE foams according to the present invention. The oil phase of the HIPE comprised 59% EHA, 23% DVB42, and 18% styrene made with 6.75% DGMO emulsifier. The HIPE was made at a 35:1 W:O ratio. The Tg of the samples was unaffected by addition of fiber.

TABLE 3
Effect of Fiber Type on Composite Tensile Properties

| | | | Tensile @ | |
|---|---|---|---|---|
| | | Fiber Level* | Failure | Tensile Modulus** |
| Example | Fiber Type | % | (Pa) | (Pa/% Strain) |
| 3a | None | 0 | 6.3 × 10⁴ | 0.28 |
| 3b | 0.2 μm ACF | 30 | 4.6 × 10⁴ | 0.36 |
| 3c | 0.2 μm ACF | 40 | 6.5 × 10⁴ | 0.44 |
| 3d | 3.2 μm ACF | 10 | 5.3 × 10⁴ | 0.36 |
| 3e | 3.2 μm ACF | 20 | 7.2 × 10⁴ | 0.82 |
| 3f | 3.2 μm ACF | 30 | 8.2 × 10⁴ | 0.95 |

*Fiber level is the percentage added by weight of monomer component (e.g., 0.5 g fiber added to a HIPE made with a 5.0 g monomer would comprise a 10% loading).
**Tensile modulus measured by linear correlation on the slope between 0% strain and 10% strain.

As can be seen the tensile at failure and the tensile modulus of the composites made using a compatible fiber according to the present invention are substantially higher than similar composites made using non-compatible fibers. Similar results were obtained with nonactivated carbon fibers.

### Example 3

A HIPE made according to the aforementioned U.S. Pat. No. 5,827,909 and having the same oil phase composition as Example 1d has 10% ACF incorporated thereinto using gentle mixing after the HIPE was poured into a cylindrical mold. The fiber-modified HIPE was cured at 65° C. overnight and cut into a continuous sheet 0.7 m in width and 2 mm thick. The sheet is further cut into sections 0.5 m long and laminated to a polyethylene film using means known to the art. This product is useful as a floor mat for collecting dirt, containing spills, removing odors from the air, providing a resilient floor surface for comfort, and a gray coloration for masking dirt accumulation. Smaller sizes of this mat may be used as a protective cover in areas like refrigerators, clothes hampers, as shelf liners, in tool boxes, and as shoe or boot inserts.

### Example 4

Foam composites cured from an oil phase having a composition according to any of the Examples 1a through 1h with a fiber level as also described in the example are comminuted into particles approximately 5 mm in diameter and used as the filler in a coat intended for winter wear. The coat is light, warm, water resistant, slump resistant, and flexible.

### Example 5.

The process outlined in Example 1 is used to form composites foams of the present invention having different formulations as detailed in Table 4. These foams were isolated and washed and dried and evaluated using the Malodor Removal Test described in the TEST METHODS section. The results show that the quickest “breakthrough” (failure) occurred in the HIPE foam sample which contain no ACF. The duration until breakthrough lengthened for the two samples with the lowest amount of 200 and 3200 micron length ACF. Of these two samples, the time taken for 50% breakthrough was shorter for the sample with longer fibers (3200 microns —see Table 4). Breakthrough was not observed even after a 60 minute period for any of the other samples, which contained higher amounts of ACF.

The time taken for 50% breakthrough of CH₃SH was calculated in the samples where breakthrough did take place. The adsorption capacity of these samples was calculated as follows (see Table 4):

Adsorption capacity=weight of probe removed by foam weight of foam

TABLE 4
Sample Descriptions, Breakthrough Times and Adsorption Capacities

| | Weight % | | |
|---|---|---|---|
| | Carbon | Time Elapsed at 50% | Capacity at 50% |
| ACF Length | Fibers | Breakthrough (min) | Breakthrough (mg/g)^{b} |
| No ACF | 0.0% | Approx. 10.7 | Approx. 0.7 |
| 200 μm | 9.1% | Approx. 19 | Approx. 0.6 |
| 200 μm | 16.7% | >60 | >3.2 |
| 200 μm | 23.1% | >60 | >1.1 |
| 200 μm | 28.6% | >60 | >2.0 |
| 3200 μm | 9.1% | Approx. 12 | Approx. 0.4 |

^{a}The oil phase composition used was: 59% EHA, 23% DVB, 18% STY, with 6.75% DGMO post add-on. The W:O ratio was 25:1. The fibers were added after HIPE formation and dispersed with minimal stirring.
^{b}Large errors are associated with these measurements due to fluctuation in gas flow through the adsorbent beds.

The disclosures of all patents, patent applications (and any patents which issue thereon, as well as any corresponding published foreign patent applications), and publications mentioned throughout this description are hereby incorporated by reference herein. It is expressly not admitted, however, that any of the documents incorporated by reference herein teach or disclose the present invention.

While various embodiments and/or individual features of the present invention have been illustrated and described, it would be obvious to those skilled in the art that various other changes and modifications can be made without departing from the spirit and scope of the invention. As will be also be apparent to the skilled practitioner, all combinations of the embodiments and features taught in the foregoing disclosure are possible and can result in preferred executions of the invention. It is therefore intended to cover in the appended claims all such changes and modifications that are within the scope of this invention.

What is claimed is:

1. A polymeric foam composite comprising:
a) an open celled foam derived from curing a High Internal Phase Emulsion having
i. a density of less than about 100 mg/cc;
ii. a glass transition temperature of from about −40° C. to about 90° C.; and
b) a compatible fiber incorporated within said foam, wherein said fibers have a mean length of less than about 5 mm and are incorporated at a level of at least about 1% by weight.

2. The polymeric foam composite of claim I wherein the fiber has a mean length of less than about 3.5 mm.

3. The polymeric foam composite of claim 2 wherein the fiber has a mean length of less than about 1.5 mm.

4. The polymeric foam composite of claim 1 wherein the fiber has a CST of from about 15 to about 50 dynes/cm.

5. The polymeric foam composite of claim 1 wherein the fiber is selected from the group including mineral fiber, glass fiber, polyethylene terephthalate fiber, aramid fiber, polyacrylonitrile fiber, polyethylene fiber, or polypropylene fiber.

6. The polymeric foam composite of claim 1 wherein the fiber is comprised substantially of carbon.

7. The polymeric foam composite of claim 6 wherein the fiber wherein the fiber is comprised substantially of activated carbon.

8. The polymeric foam material of claim 7 wherein the foam has a volume to weight ratio of water phase to oil phase in the range of from about 15:1 to about 25:1.

9. The polymeric foam according to claim 7, wherein the polymeric foam material has a glass transition temperature of from about 0° to about 40° C.

10. A method of forming a protective mat comprising the steps of:
a) providing a foam composite of claim 1; and
b) laminating thereto to a substantially impermeable backing sheet.

11. A method of removing malodors from a gaseous stream comprising the steps of:
a) providing a foam composite of claim 6; and
b) passing a gaseous stream, said stream comprising a malodorous component therethrough.

12. A method of providing insulated clothing comprising the steps of:
a) providing a fabric structure having empty pouches;
b) providing a foam composite of claim 1;
c) comminuting said foam composite into a particulate form; and
d) filling said pouches with said comminuted foam to form said insulated clothing.
